(19) United States
(12) Patent Application Publication
(10) Pub. No.: US 2008/0060208 A1
(43) Pub. Date: Mar. 13, 2008

(54) Panel Cutting Device

(76) Inventor: Piergiorgio Benuzzi, Bologna (IT)

Correspondence Address: FAY SHARPE LLP, 1100 SUPERIOR AVENUE, SEVENTH FLOOR, CLEVELAND, OH, 44114, US

(21) Appl. No.: 11/628,295

(22) PCT Filed: Dec. 13, 2005
(86) PCT No.: PCT/IB05/03958

§ 371 Date: Nov. 30, 2006

(30) Foreign Application Priority Data
Dec. 16, 2004 (IT) BO2004A000771

(51) Int. Cl. B23D 47/12

(52) U.S. Cl. 30/389

(57) ABSTRACT

Described is a device (1) for cutting panels (3), especially for panel saw machines (2) equipped with a work table (4) to support the panels (3) and a handling unit for moving the panels (3) on the work table (4) along a longitudinal axis (X). The device (1) comprises: a carriage (7) that moves in a direction parallel with the work table (4) along an axis (Y) transversal to the longitudinal axis (X); a slide (10) slidably coupled with the carriage (7) and mobile relative to the latter in an axis (Z) transversal to the work table (4); a blade (12) mounted on the slide (10) that moves it between a rest position where it is clear of the panels (3) and a working position where it engages and cuts the panels (3) positioned on the work table (4); a motor (16), fixed in relation to the carriage (7), associated with the blade (12) to generate a cutting action through a transmission unit (30) operating between the motor (16) and the blade (12).

### TECHNICAL FIELD

The present invention relates to a device for cutting panels, especially for cutting wooden panels on panel saw machines.

### BACKGROUND ART

Panel saw machines of known type are used to cut panels of various sizes. The panels are usually placed one over the other in stacks of predetermined height.

These panel saw machines, which are not illustrated herein since they well known in prior art, essentially comprise, in their basic configuration, a horizontal work table to support the stacks of panels to be cut; a pick-up, hold and feed unit, mobile in a horizontal direction X, for moving the panels along the work table; and a rotary blade device for cutting the panel or the stack of panels in a direction Y transversal to the direction X.

Depending on the height of the stack of panels to be cut, that is to say, depending substantially on the type of machine, there may be only one cutting device, normally mounted under the panel stack, and comprising a main blade and a scoring tool, or there may be two substantially similar cutting devices, one under the work table and the other above it, the blades on one device being mounted substantially opposite those on the other device: thus, each cutting device, that is to say, each blade will cut half way through the stack of panels, as described in European patent application EP-947273 by the same Applicant as the present Application.

Prior art cutting devices comprise a carriage, mobile in both directions in the Y-axis, a slide that is slidably coupled with the carriage and mounts the blade, a motor and a transmission system for driving the blade. In particular, the motor and the transmission system are installed on the slide and move as one with it under the action of lifting actuators, preferably pneumatic.

The slide runs in a direction Z transversal to the work table (on the vertical) in such a way as to move the blade between a rest position where it is clear not only of the panels or sub-panels on the work table but also of any operators that may be moving the panels or sub-panels by hand on the work table, and a working position where it engages and cuts the panels or sub-panels positioned on the work table.

Usually, the carriage performs a working stroke in Y with the blade in the cutting position and a return stroke with the blade in the rest position.

Thus, during the return stroke of the cutting device, operators attending to the machine can safely move the panels along the work table or remove sawdust or the like, whilst the panel feed unit can move the panels forward for further processing.

These prior art cutting units have several disadvantages, due mainly to the considerable weight of the motor which must be powerful enough to cut the panels and which weighs up to several hundred kilos, constituting as much as two thirds of the total moving weight of the carriage.

The weight of the motor, which is movably mounted relative to the carriage, that is to say, installed on the slide which moves up and down relative to the carriage upsets the stability of the carriage itself and may lead to troublesome vibrations, especially when the slide is near the end of its stroke.

The weight of the motor also means that the slide must have a suitably large structure and the actuators must be able to lift the motor's heavy weight, resulting in high energy consumption and slow movements.

### DISCLOSURE OF THE INVENTION

A cutting device as defined in claim 1 is therefore provided.

This invention provides an improved cutting device that is better balanced, less subject to vibrations and generally lighter.

In particular, the improved cutting device enables the panel saw machine to operate at higher speeds and generally reduces power consumption.

### DESCRIPTION OF THE DRAWINGS

The technical characteristics of the invention are clearly described in the claims below and its advantages are apparent from the detailed description which follows, with reference to the accompanying drawings which illustrate a preferred embodiment of the invention provided merely by way of example without restricting the scope of the inventive concept, and in which:

FIG. 1 is a schematic front view, with some parts cut away in order to better illustrate others, of a cutting device according to the invention, with the blade in the rest position;

FIG. 2 is a schematic front view, with some parts cut away in order to better illustrate others, of the device of FIG. 1, with the blade in the cutting position;

FIG. 3 is a schematic side view, with some parts in cross section and others cut away, of the cutting device according to the invention.

### DETAILED DESCRIPTION OF THE PREFERRED EMBODIMENTS OF THE INVENTION

With reference to the accompanying drawings, the numeral 1 denotes in its entirety a cutting device according to the present invention.

In particular, the device 1 is installed on a panel saw machine 2 for cutting panels 3, preferably of wood. The panel saw machine 2 referred to in this specification is of substantially known type and its parts are illustrated and described only insofar as is necessary to disclose the device of the invention.

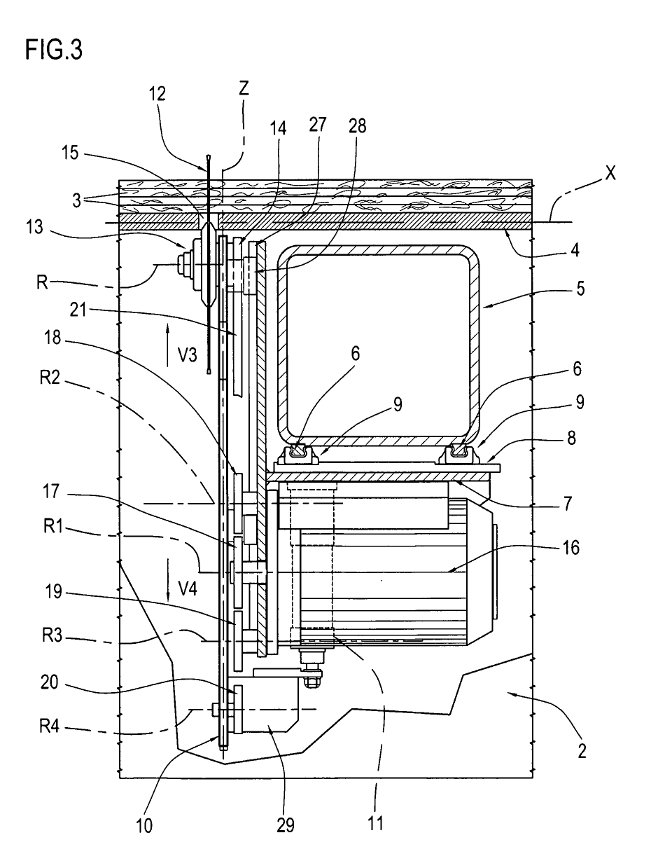

The panel saw machine comprises a horizontal work table 4 for supporting the panels 3, usually in stacks, a handling unit (not illustrated) that moves along a horizontal axis X to feed the panels 3 along the work table 4, and a device 1 supporting beam 5 located under the work table 4 and extending for the full width of the latter in a direction perpendicular to the plane of FIG. 3.

In the embodiment illustrated by way of example, the beam 5 extends along an axis Y transversal to the axis X and has a pair of rails 6 for guiding and supporting the device 1, as explained below.

With reference in particular to FIG. 3, it may be observed that the device 1 comprises a carriage 7 attached to a bracket 8 which, on the side opposite the carriage 7, is equipped with a pair of engagement elements 9 each shaped in such a way as to slidably couple with a respective rail 6.

This enables the carriage 7 to move along the beam 5 in a direction parallel with the work table 4, that is to say, along the axis Y in a working direction V1 and in a return direction V2, actuated by customary drive means which are not illustrated.

A slide 10 is slidably coupled with the carriage 7 and can move, relative to the latter, in a direction or axis Z preferably and substantially perpendicular to the work table 4.

In the accompanying drawings, the slide moves vertically in directions V3 and V4, respectively up and down in Z, driven for example by a pneumatic actuator 11 of customary type and therefore not further described, which is connected to the slide by means of an arm 29.

A blade 12, which revolves about an axis of rotation R substantially parallel with the axis X, is installed on the slide 10 through a hub 13 attached to a driven pulley 14 having a diameter D1 and being coaxial with the hub 13.

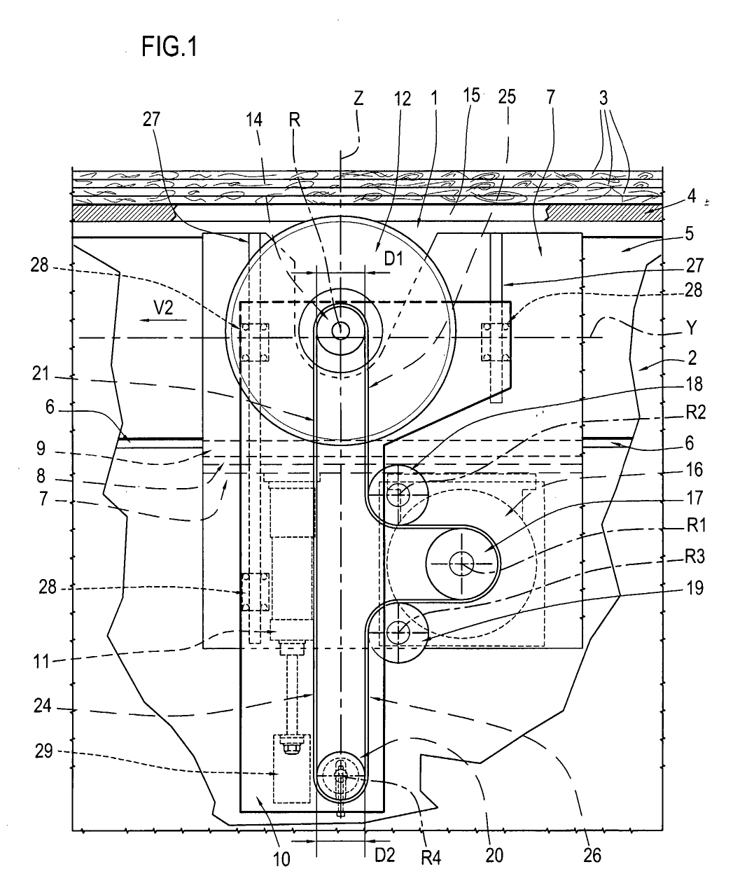

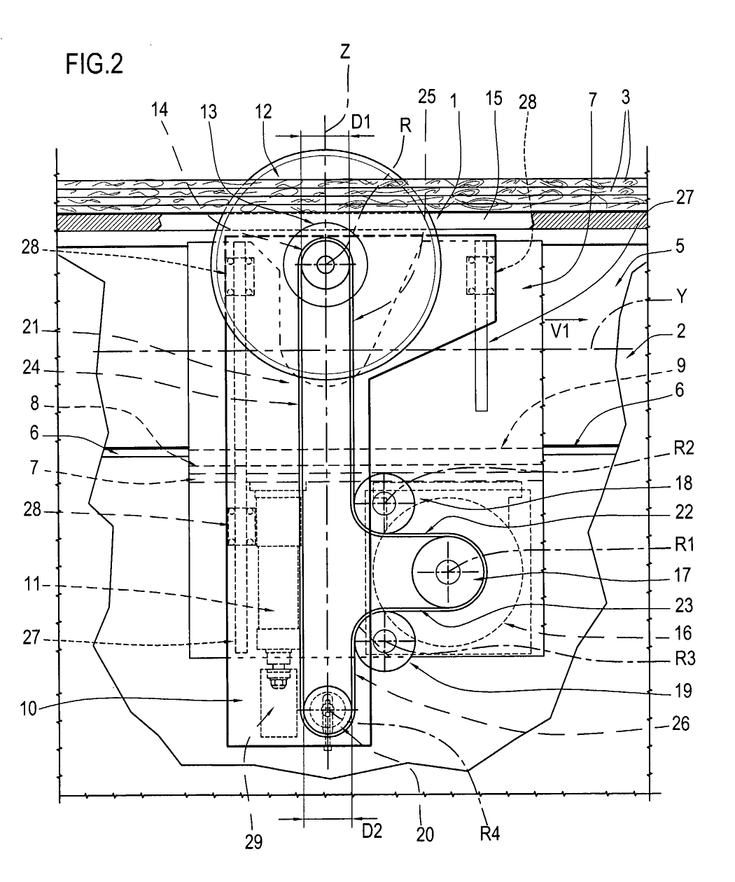

The slide 10 therefore moves the blade 12 between a rest position, shown in FIG. 1, where it is clear of the panels 3 on the work table, and a working position, shown in FIGS. 2 and 3, where it engages and cuts the panels 3 through an opening 15 made in the work table 4.

It should be noticed that in the panel saw machine 2 illustrated by way of example, the cutting device 1 according to the invention is mounted under the work table 4. However, as already stated, panel saw machines of this kind may have a second cutting device 1, not illustrated, mounted on the side of the work table 4 opposite the first. Since the structure of the second cutting device is substantially the same as the device 1 mounted under the work table, we will hereinafter refer only to the first cutting device.

The device 1 comprises a blade 12 drive motor 16 mounted on the side of the carriage 7 opposite the bracket 8 and the beam 5 and close to the bracket 8 itself. A drive pulley 17 is keyed to the output shaft of the motor 16 and revolves about an axis R1 parallel with the axis X.

Attached to the carriage 7, at the motor 16, there are two identical guide pulleys 18 and 19 that revolve about respective axes of rotation R2 and R3 parallel with the axis R1 and aligned in the axis Z.

An idle tensioning pulley 20 which revolves about a respective axis of rotation R4, parallel with the axis R and aligned with the latter in Z, is installed on the slide 10 on the side of the motor 16 and of the guide pulleys 18 and 19 opposite the driven pulley 14.

The pulley 20 has a diameter D2 equal to the above mentioned diameter D1 and the position of its axis R4 is adjustable in Z (in customary manner and therefore not illustrated) in such a way as to adjust the tension of a drive belt 21.

In particular, the belt 21 is an endless belt trained around the driven pulley 14, the idle pulley 20 and the drive pulley 17. Together with the drive pulley 17, the pulleys 18 and 19 delimit first and second belt 21 horizontal portions 22 and 23, that is to say, portions positioned along the axis Y.

The belt 21 also has a vertical section 24 opposite and parallel with a pair of sections 25 and 26 aligned in Z and delimited, respectively, by the pulleys 14 and 18 and by the pulleys 19 and 20.

Thus, the blade 12 is free to move as one with the slide 10 along Z, up in the direction V3 and down in the direction V4.

Indeed, as mentioned above, the pulley 20 moves together with the pulley 14, which means that their centre-to-centre distance remains constant: when the position of the blade 12 changes relative to the motor 16, the length of the section 24 remains constant, whilst, in the case of the belt sections 25 and 26, it is the sum of their lengths that remains constant.

Looking in more detail at the coupling between the slide 10 and the carriage 7, it should be noticed that the latter has a pair of guides 27 which are parallel with the axis Z and to which the slide 10 is slidably engaged by means of engagement elements 28 attached to the slide 10 itself.

The driven pulley 14, the drive pulley 17, the guide pulleys 18 and 19, the idle tensioning pulley 20 and the belt 12 together constitute drive means 30.

The invention, as described above, has important advantages.

With the motor attached to the carriage, the slide can be made smaller and lighter, thereby facilitating its movements.

That means the actuating piston need not be so powerful, thus reducing power consumption.

Positioning the bulk of the motor fixed to the carriage close to the rails considerably reduces vibrations and makes the carriage itself more stable.

It will be understood that the invention can be modified and adapted in several ways without thereby departing from the scope of the inventive concept. Moreover, all the details of the invention may be substituted by technically equivalent elements.

1. A device for cutting panels (3), especially for panel saw machines (2) equipped with a work table (4) to support the panels (3) and a handling unit for moving the panels (3) on the work table (4) along a longitudinal axis (X), the device comprising: a carriage (7) that moves along an axis (Y) transversal to the longitudinal axis (X); a slide (10) slidably coupled with the carriage (7) and mobile relative to the latter along a direction of movement (Z) transversal to the work table (4); a blade (12) mounted on the slide (10) that moves it between a rest position where it is clear of the panels (3) and a working position where it engages and cuts the panels (3); a motor (16), associated with the blade (12) to generate a cutting action, drive means (30) operating between the motor (16) and the blade (12), the cutting device being characterised in that the motor (16) is fixed relative to the carriage (7).

2. The device according to claim 1, characterised in that the drive means (30) are at least partly mobile in synchrony with the blade (12) along the direction of movement (Z).

3. The device according to claim 2, characterised in that the drive means (30) comprise an idle pulley (20), that is associated with the slide (10), is mobile in synchrony with the blade (12) and is aligned with the latter along the direction of movement (Z).

4. The device according to claim 3, characterised in that the drive means (30) comprise a driven pulley (14) associated with the blade (12), a drive pulley (17) associated with the motor (16) and an endless belt (21) trained at least around the driven pulley (14), the drive pulley (17) and the idle pulley (20).

5. The device according to claim 4, characterised in that the driven pulley (14) and the idle pulley (20) have equal diameters (D1, D2).

6. The device according to claim 5, characterised in that the drive means (30) comprise at least one pair of guide pulleys (18, 19) positioned at the motor (16), each guiding a respective section (22, 23) of the belt (21) along a direction (Y) substantially orthogonal to the direction of movement (Z).

7. In combination with a panel saw machine (2) equipped with a work table (4) to support panels (3) and equipped with a handling unit for moving the panels (3) on the work table (4) along a longitudinal axis (X), a cutting device comprising:
a carriage (7) that moves along an axis (Y) transverse to the longitudinal axis (X);
a slide (10) slidably coupled with the carriage (7) and mobile relative to the carriage along a direction of movement (Z) transverse to the work table (4);
a blade (12) mounted on the slide (10) that moves the blade between a rest position where the blade is clear of the panels (3) and a working position where the blade engages and cuts the panels (3);
a motor (16), associated with the blade (12) to generate a cutting action, wherein the motor (11) is fixed relative to the carriage (7); and
drive means (30) operating between the motor (16) and the blade (12).

8. The device according to claim 7, wherein the drive means (30) are at least partly mobile in synchrony with the blade (12) along the direction of movement (Z).

9. The device according to claim 8, wherein the drive means (30) comprise an idle pulley (20), that is associated with the slide (10), is mobile in synchrony with the blade (12) and is aligned with the blade along the direction of movement (Z).

10. The device according to claim 9, wherein the drive means (30) comprise a driven pulley (14) associated with the blade (12), a drive pulley (17) associated with the motor (16) and an endless belt (21) trained at least around the driven pulley (14), the drive pulley (17) and the idle pulley (20).

11. The device according to claim 10, wherein the driven pulley (14) and the idle pulley (20) have equal diameters (D1, D2).

12. The device according to claim 11, wherein the drive means (30) comprise at least one pair of guide pulleys (18, 19) positioned at the motor (16), each guiding a respective section (22, 23) of the belt (21) along a direction (Y) substantially orthogonal to the direction of movement (Z).
